(19) United States
(12) Patent Application Publication
(10) Pub. No.: US 2010/0153858 A1
(43) Pub. Date: Jun. 17, 2010

(54) Uniform virtual environments

(76) Inventors: Paul Gausman, Lebanon, NJ (US); David C. Gibbon, Lincroft, NJ (US)

Correspondence Address: AT & T LEGAL DEPARTMENT - Canavan, ATTN: PATENT DOCKETING, ROOM 2A-207, ONE AT & T WAY, BEDMINSTER, NJ, 07921, US

(21) Appl. No.: 12/316,357

(22) Filed: Dec. 11, 2008

(51) Int. Cl. G06F 3/048; G06F 15/16; H04N 7/14; G10L 17/00

(52) U.S. Cl. 715/757; 348/14.08; 704/246; 382/118

(57) ABSTRACT

A methodology is disclosed for creating a uniform virtual environment across disparate devices utilizing a plurality of delivery services. A communication system including at least two graphical display devices and a communication service platform for providing communication, a method of providing communications services comprising the steps of: receiving at the first user device a message sent by the communications service, the message including an avatar of the second user; displaying the avatar of the second user on the display of the first user; receiving at the second user device a message sent by the communication service, an avatar of a first user; and displaying the avatar of the first user on the display of the second user.

### FIELD OF THE INVENTION

The present invention relates generally to communications systems and services, and more particularly, to a system, device and memory medium for presenting video, audio, text and/or data using a uniform virtual environment across disparate devices.

### BACKGROUND OF THE INVENTION

Conference calls are an integral part of personal, corporate and government communication. As used herein, a conference call is a communication in which multiple parties participate, some or all of the parties having the ability to listen speak, view and be viewed in the voice, audio, text, video and/or graphics portion of the call. The communication may be a traditional land based wired-telephone, Voice over Internet Protocol (VoIP) telephone or a mobile or cell phone. Some conference calls are unidirectional, such as a corporate announcement or a news conference where audio and sometimes text, video and/or graphics are delivered from one point to many, in just one direction.

Conference calls have the potential to touch a plurality of communication network systems including traditional wired-telephone, the Internet and wireless networks. Conference calls also have the potential to utilize a plurality of end-user communications hardware including traditional wired-telephones, voice and video over Internet Protocol devices and wireless devices such as cell phones and Personal Digital Assistants (PDAs), to name a few. Conference calling systems, therefore, must be compatible with the systems and hardware they interact with in order to provide a high quality audio/video connection with high reliability and low latency (time delay) for the best user experience possible.

A user interface is the means by which a user interfaces or interacts with a system or device. In the context of communications systems, users interface with disparate hardware, such as landline phones, cell phones and PDAs. That hardware may include a variety of hardware-specific controls or navigation aids such as buttons, dials and touch screens, and an assortment of software, such as programs or applications, menus, and hardware/software specific commands. A user interface provides the user the means of input, allowing the user to manipulate a system and change an output, and allowing the system to produce a user's desired effect. Common user interfaces include a graphical user interface (GUI), Web browsers, touch interfaces/touch screens and tactile interfaces or other adaptive technologies allowing users with varying physical abilities to interface with a device. When a user first starts using a new communication device, he needs to become acquainted with the user interface before he can use it effectively. That typically involves setting up a user profile and learning device specific methods and techniques to effectively and efficiently interact with the new device.

As used herein, a user profile is an interface that has been customized by a user to configure the input, output, storage, display and other functions of the device to the user's liking. Some aspects of the user profile may be imposed by the device control or operating system. The “look” of a device interface may comprise aspects of its design, including elements such as colors, shapes, layout and typefaces. That type of customization is frequently called a “skin.” The “feel” of a device interface may comprise the behavior of dynamic elements of the interface such as buttons, boxes and menus. The “look and feel” as defined by a user profile increases the ease of use with a familiar interface design and enhances productivity by customizing the dynamic elements to suit the user. Users frequently do not want to give up a device or service that they have used for a while and are finally comfortable with, without a compelling reason. Users know the learning curve for a new device or service can be painful, slow and frustrating as they create their new user profile and transition all their data and applications over to the new device or service.

As used herein, a virtual environment (VE) is a networked application or networked common operating space that permits a user to both interact with the computing environment and the environment of other users. Examples of VEs are email, instant messaging, interactive video conferencing, interactive video gaming and other web-based user-interactive applications. One of the main goals of a VE is to create a feeling or psychological state where the users have a sense that they are actually present within the VE. Only since feature-rich network enabled devices and software, and widely deployed high bandwidth fixed and wireless networks have been made available and affordable have the popularity of VEs increased dramatically.

Users may interact with a plurality of network enabled devices and interact with a plurality of VEs over the course of a typical day. To maximize a VE experience, a user may establish a user profile on each device. Examples of disparate devices a single user may encounter each day are a desktop computer at the office, teleconference equipment at the office, a laptop computer at home, a PDA while commuting on the train, and a living room set-top videoconferencing device when at home. Establishing and maintaining multiple user profiles can be a time-consuming and tedious task.

Entities or individuals within a VE are easily confused if they are represented differently on different devices, especially when switching from device to device during the course of a single VE experience. For example, in a business environment, correctly and quickly identifying key individuals could mean the difference between landing and losing a client. A busy individual could start a teleconference in her office on a laptop, continue it on a PDA while being driven to the airport, and complete it on teleconference equipment in the airport frequent-flier lounge. In a gaming environment, correctly and quickly identifying a friend from a foe is critical to playing the game well when moving from a laptop device to a desktop computer device.

As used herein, user core data includes user profile preferences and any specific user-related information, such as personal contact information used to implement uniform virtual environments.

It would therefore be desirable to provide a system, device and memory medium for presenting video, audio, text and/or data employing user core data to create a uniform virtual environment across disparate devices utilizing a plurality of delivery services. To the inventors' knowledge, no such system exists.

### SUMMARY OF THE INVENTION

In accordance with a first aspect of the present invention, there is disclosed a method performed in a communication system including a first user communication device having a graphical display with a first display format, and a second user communication device having a graphical display with a second display format different from the first display format, and a communications service platform for providing a communications service to at least the first and second user communication devices. The method comprises the steps of receiving at the first user communication device a message sent by the communications service platform, the message including an avatar of a second user associated with the second user communication device, the avatar including graphical data representing a second user; displaying the avatar of the second user on the graphical display of the first user communication device to represent the second user in a graphical representation of a live communication; receiving at the second user communication device an avatar of a first user associated with the first user communication device; and displaying the avatar of the first user on the graphical display of the second user communication device to represent the first user in a graphical representation of a live communication.

The method may further comprise the steps of modifying the avatar of the second user using input from the first user, to create a modified avatar of the second user; and displaying the modified avatar of the second user on the graphical display of the first communication device. The modified avatar may be transmitted from the first user communication device to a third user communication device.

The method may further comprise the step of validating an identity of the second user in the live communication before displaying the avatar of the second user. That validating step may include identifying the second user with a recognition technique selected from the group consisting of face recognition and voice recognition.

The method may further include the step of validating an identity of the second user during the live communication; and, after validating the identity of the second user, displaying a modified version of the avatar of the second user to indicate that the identity of the second user has been verified.

The graphical representation of the live communication may include a graphical environmental framework constructed using image data from a camera.

The avatar of the second user may comprise a standardized graphical characteristic used to convey a trait of the second user.

The method may additionally include the steps of, at the communications service platform, receiving from the second user, data representing the avatar of the second user; and, at the communications service platform, storing the data representing the avatar of the second user for distribution to communication devices.

The method may further comprise the step of, at the communications service platform, in response to a graphical selection of the avatar of the second user received from the first communication device, selecting a message type to be used in transmitting a message from the first communication device to the second communication device, the selecting being based at least in part on a device type available to the second user. A characteristic of the avatar of the second user indicating a requirement of messages to be transmitted to the first user may be recognized; and the message modified to meet the requirement. That message requirement may be a requirement that no audio messages be transmitted to the first user; wherein the modifying of the message to the first user comprises converting an audio message to a text message.

In accordance with a second aspect of the present invention, there is disclosed a communication system comprising a communications service platform providing a communications service to at least a first user and a second user, the communications service platform comprising a memory storing data representing a first graphical avatar received from the first user for use in identifying the first user as a participant in a communication, and further storing data representing a second graphical avatar received from the second user for use in identifying the second user as a participant in a communication. The system further includes a first communication device for use by the first user, the first communication device being in communication with the communications service platform; the first communication device comprising a graphical display for displaying in a first display format, and a computer readable memory having stored thereon instructions that, when executed by the first communication device, cause the first communication device to receive the second graphical avatar from the communications services platform, to modify the second graphical avatar for display using the first display format, and to display the second graphical avatar on the first communication device to identify the second user as a participant in a communication with the first user.

The system may further comprise a second communication device for use by the second user, the second communication device being in communication with the communications service platform; the second device comprising a graphical display for displaying in a second display format different from the first display format, and a computer readable memory having stored thereon instructions that, when executed by the second communication device, cause the second communication device to receive the first graphical avatar from the communications services platform, to modify the first graphical avatar for display using the second display format, and to display the first graphical avatar on the second communication device to identify the first user as a participant in a communication with the second user.

The instructions stored on the computer readable memory of the first communication device may further cause the first communication device to modify the avatar of the second user using input from the first user, to create a modified avatar; and to display the modified avatar.

In accordance with a third aspect of the present invention, there is disclosed a method for conducting a video conference including a group of participants including at least a first participant in an environment in a field of view of a camera. The method comprises the steps of constructing a graphical environmental framework using image data from the camera; identifying the first participant using a face recognition algorithm applied to image data from the camera; placing at a location in the environmental framework corresponding to a location of the first participant, an avatar representing the first participant; and displaying the environmental framework including the avatar to a second conference participant.

The method may further include the steps of verifying an identity of the first participant using a voice recognition algorithm to analyze a voice signal; and modifying the displayed avatar of the first participant to indicate that the identity has been verified.

The method may further comprise the step of altering the displayed avatar of the first participant to indicate that a voice signal is being received.

The method may additionally include the steps of receiving instructions from the second conference participant to alter the avatar of the first participant; and altering the displayed avatar of the first participant according to the instructions.

The method may further comprise the steps of placing at a location in the environmental framework, an avatar representing the second participant; and displaying the environmental framework including the avatars of the first and second participants.

These aspects of the invention and further advantages thereof will become apparent to those skilled in the art as the present invention is described with particular reference to the accompanying drawings.

### BRIEF DESCRIPTION OF THE DRAWINGS

FIG. 1 is a functional block diagram of a system in accordance with the present invention;

FIG. 2 is a functional block diagram of an exemplary virtual environment system in accordance with the present invention;

FIG. 3 is block diagram of user information in accordance with the present invention; and

FIG. 4 is a method of use 400 in accordance with the present invention.

### DESCRIPTION OF THE INVENTION

Embodiments of the invention will be described with reference to the accompanying drawing figures wherein like numbers represent like elements throughout. Before embodiments of the invention are explained in detail, it is to be understood that the invention is not limited in its application to the details of the examples set forth in the following description or illustrated in the figures. The invention is capable of other embodiments and of being practiced or carried out in a variety of applications and in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

A goal of the present invention is to provide a uniform or largely consistent virtual environment (VE) for users as they utilize disparate devices to access an information presentation service such as a teleconference or videoconference. Specifically, the invention maintains a uniform VE for users while participating in a VE experience as accessed by a variety of network access devices. Switching between network access devices during a VE experience while maintaining as much homogeneity of the VE as possible can help users work through the visualization more smoothly and focus on the content of the experience and not worry about deciphering the interface and getting used to the new environment.

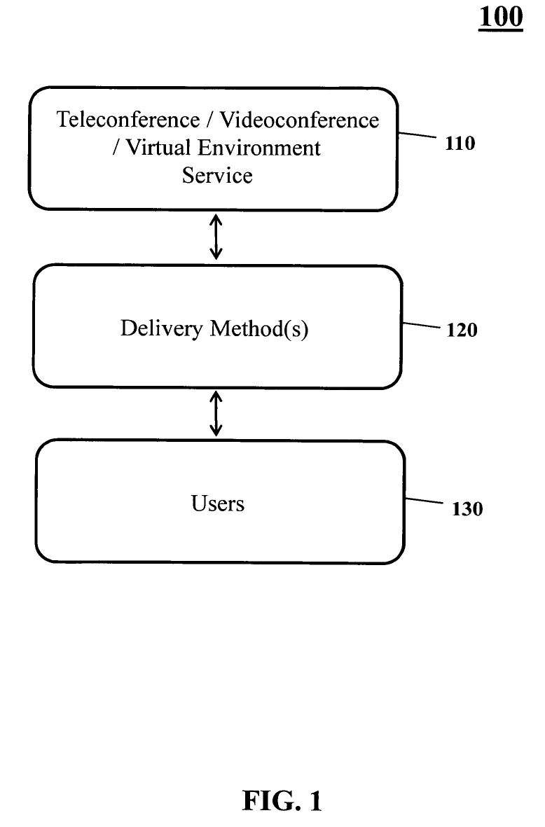

FIG. 1 is a functional block diagram of a system 100 in accordance with the present invention. The service 110 is an exemplary teleconference/videoconference service providing audio, video and the VE within which users can interact with the computing environment and the environment of other users. The service 110 communicates via bidirectional communication connections utilizing delivery method(s) or service(s) 120. Examples of delivery methods are short message service (SMS), multimedia messaging service (MMS), email, voice over Internet protocol (VoIP), internet protocol television (IPTV), and instant messaging (IM). The delivery methods are accessible over the Internet or other public or private telecommunications networks, and communicate with users 130 in a bidirectional manner. There may be two or more users participating in one exemplary VE. Once the VE session is initiated, users can participate in the voice and video conference while interacting with the VE.

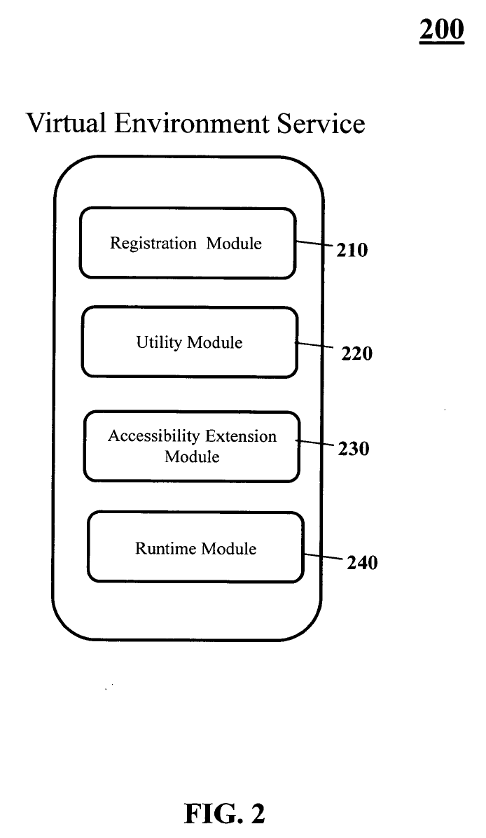

FIG. 2 is a functional block diagram of an exemplary virtual environment service 200 in accordance with the present invention. The service 200 provides a uniform VE across disparate devices as implemented by the following system modules. The registration module 210 may include several user specific sections of initial system setup. Those sections may include data representing users registering with the service, users registering devices which will display the content, users selecting basic frameworks within which the VE service content will be present, users selecting a basic avatar format for use within the frameworks and users informing the VE service of the preferred communication services to use to facilitate the VE service. The user registration module establishes a Web interface between the service and the user whereby the service and all modules can be accessed. Users register the various devices they wish to use to display the VE service content.

Users also select basic frameworks or VE templates corresponding to a simple (2-dimensional) or a more complex (3-dimensional) framework into which information will be presented on corresponding devices. The framework may be an environment foreground, background and layout such as a live video feed of the actual conference room and participants, a mock conference room scene, or stored scenes such as a ski chalet scene or a beach scene. Framework icons, symbols, logos, trademarks and the like may be system imposed and may be unchangeable, and may represent hospitals, police stations, airports and the like.

An avatar or graphical representation of the user is also selected during registration. The avatar may be a live video feed of the user or some other user-selected representation of the user. The avatar represents the way the user interacts with the computing environment and with other users. Users may store default avatars for how they would like themselves represented to others as part of their user core data. Locally stored avatar preferences may, however, override the default avatars. Both frameworks and avatars may be shared with other users.

System imposed avatars for particular types of individuals, such as police, fire, doctors, emergency services and the like may be unchangeable to facilitate quick and unmistakable identification. Trust between users of virtual environment services is essential as sensitive business, personal and financial information may be exchanged or discussed. The level or status of trust between participants of the VE service, therefore, may be conveyed by how an avatar is presented in the VE. For example, a trust verification or validation may be represented by a glow around an avatar, or by other indicia. Established methods, such as Secure Socket Layer (SSL) technology and Transport Layer Security (TLS) encryption may be utilized, as are well known by those skilled in the art, as well as numeric-based rating systems for gauging buyer and/or seller trust such as those methods utilized by organizations such as Amazon.com® and eBay®, and other passive and/or active trust determining methods being developed. Recognizing, validating, modifying and representing trust relationships quickly and accurately are essential as participants dynamically enter and exit a VE session.

A utility module 220 allows the user to modify the VE system “look and feel” after initial setup. For example, the utility module 220 permits the user to select devices, and to select and modify frameworks, avatars and communication services. Selection and modification of frameworks and avatars is necessary as available bandwidth conditions may vary over the course of a VE session. Furthermore, device limitations may additionally restrict how frameworks and avatars are presented by a particular network access device used to participate in a VE session. When maximum bandwidth conditions are available and a device can support it, the richest frameworks and avatars are applied; for example, the VE system may provide a live feed of the room and participants. Conversely, as bandwidth conditions and/or device capabilities are less than optimal, functionality and/or features of the frameworks and avatars may be reduced. Avatars can be selected to represent specific people or groups of people whom the user may interact with in the VE. The address book or contact list of a cell phone, PDA or computer may be used to develop the avatar population.

An avatar of a user may be modified by another user for display in the other user's VE. That modified avatar may be transmitted to third party users or to a system platform by access by third party users. For example, a user may be perceived by other users as trustworthy, as having a particular political alignment, or as having other characteristics. Those characteristics may be reflected in an avatar that is modified for display to other parties. That avatar may furthermore be viewed by the represented party to evaluate how he or she is perceived by other parties.

The avatar may be utilized in facilitating the process of sending a message. In response to a graphical selection of the avatar by a user, the system of the invention may select a message type to be used in transmitting a message to an intended recipient represented by the avatar. The avatar may indicate to the system that a particular type of device is available to the intended recipient, or indicate that the recipient has particular accessibility requirements. The system may alter the message for reception by that recipient. For example, if an intended recipient is hearing-impaired, then clicking on that recipient's avatar to send a message may cause the system to apply speech-to-text conversion to the message before sending it.

An accessibility extension module 230 modifies the system “look and feel” by allowing adaptive technologies such as tactile displays, speech to text functionality, and others to be incorporated into the system, permitting users with varying physical abilities, such as touch, vision, hearing and others, to use the VE system.

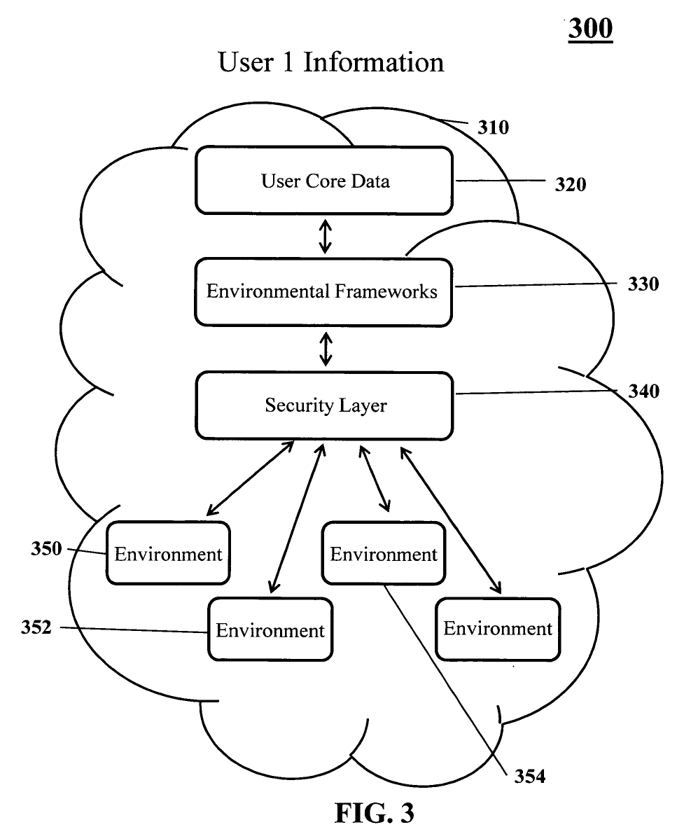

A runtime module 240 provides the VE environment within which a networked application or networked common operating space permits users to interact with both the computing environment and the environment of other users. The module includes sections for inviting users to a spontaneous or planned VE session, for initiating a VE session, for implementing multiple VE sessions for individual users, for dynamically adding, deleting or changing individual user VE sessions and for terminating a VE session. A key aspect of the present invention is that the VE service has the ability to create uniform VEs across disparate devices. In that regard, the runtime module 240 will have the ability to support multiple VEs of a particular user simultaneously. For example, a user is participating in a videoconference on her desktop computer, but wishes to use her PDA to continue to participate in the videoconference. In that example, a second VE session can be initiated by the user on the PDA prior to terminating the first VE session on the desktop computer. That aspect of the invention will be discussed further in the description of FIG. 3, below.

FIG. 3 is block diagram showing user information 300 in accordance with the present invention. The user cloud 310 encompasses information that enables, in this example, a first user to participate in a VE service. The user core data 320 and the environmental frameworks 330 include information provided by the user and may be stored and processed remotely by the VE service. A security layer 340 is provided to assure message delivery security, such as encryption and virus checking. The security layer 340 may be processed locally by the device, provided by the VE service or processed both by the device and the VE service.

Environment 350 may be a desktop computer environment with high processing capability, a video camera and high bandwidth, environment 352 may be a PDA also with high processing capability, but with lower display capabilities and varying bandwidth capability depending on location. Environment 354 may be an IPTV located in a user's living room with nominal processing capability, a video camera and high bandwidth. A plurality of environments are possible as supported by the VE service.

The VE system as described in FIG. 2, utilizing user information described in FIG. 3 implements the VE service of the invention for presenting video, audio, text and/or data in a uniform virtual environment having a particular “look and feel” as a user moves from one environment, with associated device processing, device display and network bandwidth limitations, to another environment, with its own set of associated limitations.

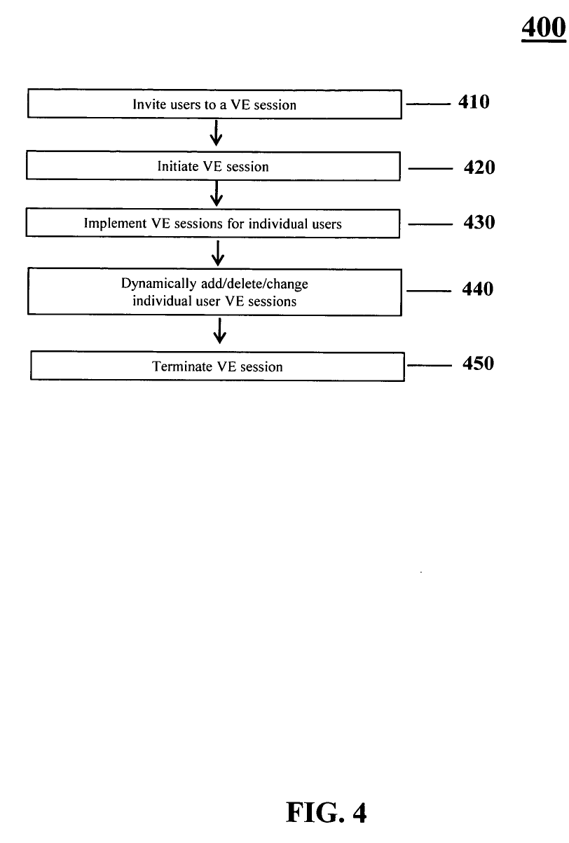

FIG. 4 is a method 400 in accordance with the present invention. In step 410, a meeting host may invite another user or users to a VE session in a virtual meeting room/living room. The session could be planned in advance or be initiated spontaneously.

In step 420, the VE session is initiated when two users, using network access devices of their choice, start the VE teleconference.

In step 430, additional users join the in-progress VE session, also using network access devices of their choice. At that moment, all participants are in their respective VEs, interacting with their computing environment and the environment of all the other participating users. User core data, preferences regarding 2-dimensional and 3-dimensional environmental frameworks, avatars, combined with device capabilities and network connection limitations determine the richness of the user experience. Users may be uniquely identified by avatars, face and/or voice recognition to validate or confirm identity and to determine exact user location in the VE. After an identity of a user is validated during the live communication, a modified version of the avatar of that user may be displayed to indicate that the identity of the user has been verified.

In addition to the VE service, services not related to VE services, such as calling a personal cell phone or PDA of a VE participant, send an instant message or an email to a VE participant, or talk directly into the voice connection of the room while the VE session is in progress may be implemented to complement the VE service experience.

In step 440, the VE session dynamically adapts to add, delete and change individual user VEs. This can happen, for example when a user joins the VE, when a user leaves the VE, when connectivity bandwidth changes for a user or when a user changes or adds a network access device. A primary goal of the present invention is to create a uniform virtual environment of “look and feel” across disparate devices with varying levels of processing power, display capability and network connection bandwidth.

The VE system may apply network layer security, as is well known by those skilled in the art. This may include utilizing a security layer with at least a 128 bit encryption key. The VE system may also select the optimal delivery methods/services to safely, reliably and expeditiously implement the VE service while providing a uniform VE interface. This may include utilizing a specific delivery method such as SMS, MMS or VoIP. By allowing the VE service to determine the delivery method, the most efficient services as determined by network conditions, such as traffic, availability and technology/protocol changes could be utilized. The security layer and delivery methods may be set by user preferences.

In step 450, when the last two networked users terminate their connection, the VE session is over.

Users may share an experience in a VE, such as distance learning or training, a shared presentation, a virtual showroom, consultation services or co-watching an event such as a speech, sporting event or other such gathering.

Stationary network access devices with video capability could be used to create 3-dimensional models of a location they normally occupy or be adapted to model multiple spaces. The model may be used to create a 3-dimensional map for a building walk-through, to create a visual inventory of a space, to create a virtual showroom, to create a virtual trip planner or drive through environment linked to other services such as directions or other navigation or location devices, or to create promotional, advertising and marketing materials and presentations.

The foregoing detailed description is to be understood as being in every respect illustrative and exemplary, but not restrictive, and the scope of the invention disclosed herein is not to be determined from the description of the invention, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention.

We claim:

1. In a communication system including a first user communication device having a graphical display with a first display format, and a second user communication device having a graphical display with a second display format different from the first display format, and a communications service platform for providing a communications service to at least the first and second user communication devices, a method of providing communications services comprising the steps of:
receiving at the first user communication device a message sent by the communications service platform, the message including an avatar of a second user associated with the second user communication device, the avatar including graphical data representing a second user;
displaying the avatar of the second user on the graphical display of the first user communication device to represent the second user in a graphical representation of a live communication;
receiving at the second user communication device an avatar of a first user associated with the first user communication device; and
displaying the avatar of the first user on the graphical display of the second user communication device to represent the first user in a graphical representation of a live communication.

2. The method of claim 1, further comprising the steps of:
modifying the avatar of the second user using input from the first user, to create a modified avatar of the second user; and
displaying the modified avatar of the second user on the graphical display of the first communication device.

3. The method of claim 2, further comprising the step of:
transmitting the modified avatar from the first user communication device to a third user communication device.

4. The method of claim 1 further comprising the step of:
validating an identity of the second user in the live communication before displaying the avatar of the second user.

5. The method of claim 4 wherein the validating step comprises:
identifying the second user with a recognition technique selected from the group consisting of face recognition and voice recognition.

6. The method of claim 1 further comprising the steps of:
validating an identity of the second user during the live communication; and
after validating the identity of the second user, displaying a modified version of the avatar of the second user to indicate that the identity of the second user has been verified.

7. The method of claim 1 wherein the graphical representation of the live communication includes a graphical environmental framework constructed using image data from a camera.

8. The method of claim 1 wherein the avatar of the second user comprises a standardized graphical characteristic used to convey a trait of the second user.

9. The method of claim 1, further comprising the steps of:
at the communications service platform, receiving from the second user, data representing the avatar of the second user; and
at the communications service platform, storing the data representing the avatar of the second user for distribution to communication devices.

10. The method of claim 1, further comprising the step of:
at the communications service platform, in response to a graphical selection of the avatar of the second user received from the first communication device, selecting a message type to be used in transmitting a message from the first communication device to the second communication device, the selecting being based at least in part on a device type available to the second user.

11. The method of claim 10, further comprising the steps of:
at the communications service platform, recognizing a characteristic of the avatar of the second user indicating a requirement of messages to be transmitted to the first user; and
modifying the message to meet the requirement.

12. The method of claim 11, wherein
the message requirement is a requirement that no audio messages be transmitted to the first user; and
wherein the modifying of the message to the first user comprises converting an audio message to a text message.

13. A communication system, comprising:
a communications service platform providing a communications service to at least a first user and a second user, the communications service platform comprising a memory storing data representing a first graphical avatar received from the first user for use in identifying the first user as a participant in a communication, and further storing data representing a second graphical avatar received from the second user for use in identifying the second user as a participant in a communication; and
a first communication device for use by the first user, the first communication device being in communication with the communications service platform; the first communication device comprising a graphical display for displaying in a first display format, and a computer readable memory having stored thereon instructions that, when executed by the first graphical display device, cause the first communication device to receive the second graphical avatar from the communications services platform, to modify the second graphical avatar for display using the first display format, and to display the second graphical avatar on the first communication device to identify the second user as a participant in a communication with the first user.

14. The system of claim 13, further comprising:
a second communication device for use by the second user, the second communication device being in communication with the communications service platform; the second device comprising a graphical display for displaying in a second display format different from the first display format, and a computer readable memory having stored thereon instructions that, when executed by the second communication device, cause the second communication device to receive the first graphical avatar from the communications services platform, to modify the first graphical avatar for display using the second display format, and to display the first graphical avatar on the second communication device to identify the first user as a participant in a communication with the second user.

15. The system of claim 14, wherein the instructions stored on the computer readable memory of the first communication device further cause the first communication device to modify the avatar of the second user using input from the first user, to create a modified avatar; and to display the modified avatar.

16. A method for conducting a video conference including a group of participants including at least a first participant in an environment in a field of view of a camera, the method comprising the steps of:
constructing a graphical environmental framework using image data from the camera;
identifying the first participant using a face recognition algorithm applied to image data from the camera;
placing at a location in the environmental framework corresponding to a location of the first participant, an avatar representing the first participant; and
displaying the environmental framework including the avatar to a second conference participant.

17. The method of claim 16, further comprising the steps of:
verifying an identity of the first participant using a voice recognition algorithm to analyze a voice signal; and
modifying the displayed avatar of the first participant to indicate that the identity has been verified.

18. The method of claim 16, further comprising the step of:
altering the displayed avatar of the first participant to indicate that a voice signal is being received.

19. The method of claim 16, further comprising the steps of:
receiving instructions from the second conference participant to alter the avatar of the first participant; and
altering the displayed avatar of the first participant according to the instructions.

20. The method of claim 16, further comprising the steps of:
placing at a location in the environmental framework, an avatar representing the second participant; and
displaying the environmental framework including the avatars of the first and second participants.
